(19) United States
(12) Patent Application Publication
(10) Pub. No.: US 2024/0238699 A1
(43) Pub. Date: Jul. 18, 2024

(54) APPARATUS FOR PREVENTING IMPURITIES IN A WASHING FLUID FROM CLOGGING AN UNDERDRAIN AND METHODS FOR PREVENTING CLOGGING OF THE UNDERDRAIN AND/OR MONITORING THE APPARATUS

(71) Applicant: Roberts Marketing DE, Inc., Wilmington, DE (US)

(72) Inventors: R. Lee Roberts, Rose Valley, PA (US); Matthew Roberts, Downingtown, PA (US)

(21) Appl. No.: 18/098,583

(22) Filed: Jan. 18, 2023

(51) Int. Cl. B01D 24/46; B01D 24/20; B01D 24/48; C02F 1/00

(52) U.S. Cl. CPC B01D 24/4631; B01D 24/205; B01D 24/4884; C02F 1/001; C02F 2209/03; C02F 2303/14; C02F 2303/16

(57) ABSTRACT

Devices and methods associated with these devices for significantly improving the efficiency of an existing or new treatment unit having a granular media filter bed supported above an underdrain for removing impurities passing through the filter bed. The devices and methods are specifically designed to prevent clogging of the underdrain to improve the operation and efficiency of the treatment unit. The devices and methods are directed to providing trapping structures and methods that allow a washing fluid to pass through the trapping structures but traps impurities in the washing fluid that have the potential of partially or completely clogging the underdrain. Further, one or more sensors are provided to determine if the trapping structure is performing properly.

### FIELD OF THE INVENTION

Preferred forms of the present invention are directed to an apparatus for preventing impurities in a washing fluid (e.g., water) from clogging an underdrain of filters, clarifiers or other devices designed and operated to remove impurities from influent (i.e., a liquid to be treated by the clarifier or filter). The preferred forms of present invention are extremely advantageous as a partially or completely clogged underdrain requires a costly and time consuming rehabilitation process to be performed including removing all media in the filter, clarifier or other device designed and operated to remove impurities from influent as well as removal and/or replacement of the partially or completely clogged underdrain. Notably, during the rehabilitation process the filter, clarifier or other device designed and operated to remove impurities from influent cannot function to remove impurities thereby significantly reducing the efficiency of the impurity removal device.

The apparatus can take many forms/configurations to prevent impurities in a washing fluid from clogging an underdrain. Preferred forms of the apparatus include but are not limited to an anti-clogging member or device operably associated with an outlet or other relevant portion of a washing fluid delivery vessel, conduit or pipe such that washing fluid to be directed to and through an underdrain must pass through the anti-clogging member or device prior to entering the underdrain and/or passing through the underdrain.

Preferably, the underdrain anti-clogging member or device includes, inter alia, a screening portion configured to allow a washing fluid to pass through the underdrain anti-clogging member or device and subsequently travel into and through the underdrain while trapping in the underdrain anti-clogging member or device impurities in the washing fluid that have the potential to clog the underdrain. The sizing of the openings in the screening portion of the underdrain anti-clogging member or device is designed to allow free flow or not unduly restrict the flow of a washing fluid while trapping impurities in the washing fluid that have the potential of clogging the underdrain.

The underdrain anti-clogging member or device can be configured to be removable so that the underdrain anti-clogging member or device can be removed to be cleaned or replaced with a new underdrain anti-clogging member or device.

Preferred forms of the present invention also include one or more sensors for monitoring the underdrain anti-clogging member or device to ensure that the underdrain anti-clogging member or device is functioning properly and/or has not become saturated with impurities preventing or unduly restricting the flow of washing fluid through the underdrain anti-clogging member or device.

In a preferred embodiment, a first pressure sensor senses, during a washing cycle, mode, phase or stage, the pressure of the flow of a washing fluid prior to entering the underdrain anti-clogging member or device and a second sensor senses, during a washing cycle, mode, phase or stage, the pressure of the flow of washing fluid exiting or escaping from the underdrain anti-clogging member or device. By monitoring these two sensors including but not limited to pressure differential between the two sensor pressure readings, it is possible to make sure that the screening portion of the underdrain anti-clogging member or device has not deteriorated to ensure that the screening portion is performing its trapping function and also make sure that the underdrain anti-clogging member or device has not become partially or completely clogged, filled or saturated with impurities unduly restricting the flow a washing fluid through the underdrain anti-clogging member or device.

Preferred forms of the present invention further include methods for preventing clogging of an underdrain and/or monitoring an apparatus (e.g., underdrain anti-clogging member or device) configured to prevent clogging of an underdrain to ensure that the apparatus is properly performing all functions associated therewith.

Another aspect of a preferred embodiment of the present invention is to provide a pressure sensor in the flume or space below the underdrain to monitor the pressure of washing fluid flowing in the flume during a washing cycle, mode, phase or stage. The pressure sensor is operably connected to a controller controlling a pump and/or valve that controls the flow of a washing fluid to the treatment unit during a washing cycle, mode, phase or stage. If the pressure sensor reading is above a predetermined value, the controller will shutoff the pump and/or close the valve to cease the flow of washing fluid to the flume or space below an underdrain to prevent the underdrain from being damaged due to excess pressure in the washing fluid that will pass into and through the underdrain.

### BACKGROUND OF THE INVENTION

In a treatment unit for treating water or wastewater having a bed of granular media including one or more layers of filter/clarifier media configured to remove impurities from the liquid to be processed (i.e., influent), it is imperative that the granular media be periodically washed to remove impurities trapped in the granular media during a filtration or impurity removal cycle, mode, stage or phase. If the washing cycle, mode, stage or phase is not properly performed, the efficiency of the treatment unit will be reduced as any subsequent filtering cycle or impurity removal cycle, mode, stage or phase will be shortened which necessarily will reduce the time the treatment unit can be operated to treat liquid to be processed.

A key component in a washing cycle, mode, stage or phase of a treatment unit employing a granular media to remove impurities is an underdrain. The underdrain can take many forms including but not limited to a plurality of underdrain lateral blocks directly or indirectly supporting a filter bed having one or more layers of filter media configured to remove impurities from a fluid passing through the filter bed of the treatment unit during a filtering cycle or impurity removal cycle, mode, stage or phase. The underdrain may be equipped with one or more components (e.g., porous plate) allowing the underdrain to directly support the filter bed. Alternatively, where the underdrain is not equipped with one or more components to directly support the filter bed, one or more gravel layers can be positioned between the filter bed and the underdrain.

The underdrain is a vital component in effectively performing a washing cycle, mode, stage or phase. This is true regardless of whether the treatment unit is configured to have influent passing upwardly (e.g., upflow filter), downwardly (e.g., downflow filter) or both upwardly and downwardly (e.g., biflow filter) through the treatment unit during a filtering cycle or impurity removal cycle, mode, stage or phase.

If the underdrain becomes completely or partially clogged, it cannot perform its vital functions to the operation of the treatment unit. As the treatment unit undergoes numerous washing cycles, modes, stages or phases, any impurities in the washing fluid will build up in the underdrain and ultimately partially or completely clog the underdrain preventing the underdrain from performing its vital functions in both washing cycles, modes, stages or phases and filtering cycles or impurity removal cycles, modes, stages or phases. In the case of washing cycles, modes, stages or phases, a partially or completely clogged underdrain will prevent the underdrain from directing a washing fluid uniformly through the filter bed to uniformly remove impurities trapped by the filter bed during a washing cycle, mode, stage or phase reducing the effectiveness of the treatment in subsequent filtering cycles or impurity removal cycles, modes, stages or phases.

Hence, there is a significant need for an apparatus and/or method that prevents impurities in a washing fluid from building up in the underdrain to partially or completely clog the underdrain. There is also a significant need for an apparatus and/or method that monitors any device configured to prevent impurities in the washing fluid from entering in and becoming lodged in the underdrain to make sure that the apparatus has not become clogged, filled or saturated with impurities to an extent that it cannot perform its vital functions or has not deteriorated over time so that it cannot perform the vital functions it has been designed to achieve.

### OBJECTS AND SUMMARY OF THE INVENTION

An object of a preferred form of the present invention is to provide a novel and unobvious device and/or process/method for preventing an underdrain from becoming partially or completely clogged by impurities present in a washing fluid directed into and through the underdrain.

Another object of a preferred form of the present invention is directed to an underdrain anti-clogging member or device operably associated with a washing fluid delivery vessel, conduit or pipe that prevents impurities of a washing fluid that have the potential of clogging an underdrain from entering and/or becoming lodged in the underdrain.

A further object of a preferred form of the present invention is directed to an underdrain anti-clogging member or device configured to allow a washing fluid to enter the underdrain while trapping impurities that have the potential of clogging the underdrain from entering and becoming lodged in the underdrain.

Still another object of a preferred form of the present invention is to provide an underdrain anti-clogging member or device having a screening portion including a plurality openings sized to not unduly restrict the flow of a washing fluid through the underdrain anti-clogging member or device while trapping in the underdrain anti-clogging member or device impurities that have the potential of clogging an underdrain.

Still a further object of a preferred form on the present invention is to provide an underdrain anti-clogging member or device that can be removed to be cleaned or replaced with a new underdrain anti-clogging member or device.

Yet a further object of a preferred form on the present invention is to provide an underdrain anti-clogging member or device that can be removed to be cleaned or replaced with a new underdrain anti-clogging member or device without altering one or more components of the treatment unit to such an extent that the one or more components of the treatment unit cannot be reused after the removal of the underdrain anti-clogging member or device.

Yet still another object of a preferred form on the present invention is to provide an underdrain anti-clogging member or device and one or more sensors operably associated therewith to ensure that the underdrain anti-clogging member or device is properly functioning to perform any and all functions associated therewith.

Another object of a preferred form of the present invention is to provide one or more methods that prevents impurities present in a washing fluid that have the potential of clogging an underdrain from entering and becoming lodged in the underdrain.

A further object of a preferred form of the present invention is to provide one or more methods for monitoring an underdrain anti-clogging member or device to ensure that the underdrain anti-clogging member or device is properly functioning to perform any and all functions associated therewith.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention. Further, the above is not an exhaustive list of the advantages and objects of the preferred forms of the present invention. Other advantages and objects of preferred forms of the present invention will be readily appreciated from the description of the preferred forms of the present invention.

In summary, one preferred embodiment of the present invention is directed to an apparatus for preventing clogging of an underdrain of a treatment unit having a filter bed for treating water or wastewater. The apparatus includes an underdrain anti-clogging device operably associated with a washing fluid delivery member for directing washing fluid to the underdrain of the treatment unit to wash the filter bed of the treatment unit. The underdrain anti-clogging device is configured to allow the washing fluid to pass through the underdrain anti-clogging device and into the underdrain while trapping impurities in the washing fluid to prevent the impurities in the washing fluid from entering or clogging the underdrain.

Another preferred embodiment of the present invention is directed to a method for preventing clogging of an underdrain of an existing or new treatment unit having an underdrain and a filter bed for treating water or wastewater. The method comprising the steps of: (a) providing an underdrain anti-clogging device operably associated with a washing fluid delivery member for directing washing fluid to the underdrain of the treatment unit to wash the filter bed of the treatment unit; and, (b) configuring the underdrain anti-clogging device to allow the washing fluid to pass through the underdrain anti-clogging device and into the underdrain while trapping impurities in the washing fluid to prevent the impurities in the washing fluid from entering or clogging the underdrain.

A further embodiment of the present invention is directed to a treatment unit for treating water or wastewater. The treatment unit includes a filter bed having one or more layers of filter media, an underdrain disposed below the filter bed, a compartment for housing the filter bed and the underdrain and a washing fluid delivery system for directing a washing fluid upwardly through the underdrain and into and through the filter bed. An underdrain anti-clogging device is operably associated with the washing fluid delivery system. The underdrain anti-clogging device is configured to allow the washing fluid to pass through the underdrain anti-clogging device and into the underdrain while trapping impurities in the washing fluid to prevent the impurities in the washing fluid from entering the underdrain.

Still a further preferred embodiment of the present invention is directed to a method of monitoring, during a washing cycle, fluid pressure of a washing fluid prior to entering an underdrain of an existing or new treatment unit having an underdrain and a filter bed for treating water or wastewater. The method comprising the steps of: (a) providing a pressure sensor in a flume or space below the underdrain to monitor a fluid pressure of a washing fluid during a washing cycle in which a washing fluid flows through the flume or space below the underdrain and into and through the underdrain; (b) operably associating the pressure sensor with a controller that controls the flow of the washing fluid to the flume or space below the underdrain; and, (c) discontinuing the flow of the washing fluid to the flume or space below the underdrain when the pressure sensed by the pressure sensor exceeds a predetermined value to prevent damaging the underdrain.

The above summary describes preferred forms of the present invention and is not in any way to be construed as limiting the claimed invention to the preferred forms.

### BRIEF DESCRIPTION OF THE DRAWINGS

FIG. 1 is a perspective view of a preferred underdrain anti-clogging member, device or insert with a preferred fluid pressure sensor removed therefrom.

FIG. 2 is an elevational view of the preferred underdrain anti-clogging member, device or insert of FIG. 1.

FIG. 3 is a cross-sectional schematic view of one preferred treatment unit having a preferred underdrain anti-clogging member, device or insert with a fluid pressure sensor disposed in a flume or space below the underdrain of the treatment unit and a second fluid pressure sensor disposed outside of the housing of the treatment unit.

FIG. 4 is a cross-sectional schematic view of another preferred treatment unit similar to the treatment unit depicted in FIG. 3 in which a detachable elbow connects a washing fluid delivery vessel, conduit or pipe to the treatment unit and a preferred underdrain anti-clogging member, device or insert operably connected to the washing fluid delivery vessel, conduit or pipe so that the preferred underdrain anti-clogging member, device or insert can be readily removed by merely detaching an end of the elbow from the treatment unit and manipulating (e.g., moving) the elbow to a position that allows for removal of the preferred underdrain anti-clogging member, device or insert.

FIG. 5 is a cross-sectional schematic view of another preferred treatment unit similar to the treatment unit depicted in FIG. 4 in which a T-connector connects a washing fluid delivery vessel, conduit or pipe to the treatment unit and a preferred underdrain anti-clogging member, device or insert operably connected to the washing fluid delivery vessel, conduit or pipe so that the preferred underdrain anti-clogging member, device or insert can be readily removed by removing a removable end cap of the T-connector.

### DETAILED DESCRIPTION OF THE PREFERRED

### Embodiments of the Invention

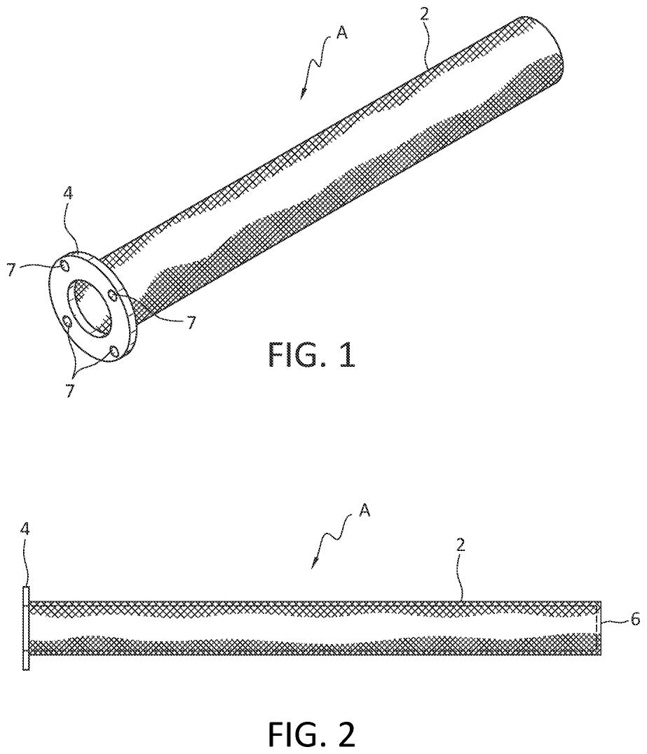

The preferred forms of the invention are described below with reference to FIGS. 1 to 5. The appended claims are not limited to the preferred forms and no term and/or phrase used herein is to be given a meaning other than its ordinary meaning unless it is expressly stated otherwise.

The term “filter bed” includes any structure having one or more layers of granular media for removing impurities in a fluid (e.g., water) to be treated directed through the one or more layers of granular media.

The phrase “washing fluid” encompasses and includes any fluid directed through a granular media to remove impurities trapped in a filtering cycle or impurity removal cycle, mode, stage or phase. By way of example and without limitation, “washing fluid” includes a washing fluid directed in the same or opposite direction of influent traveling through the granular media during a filtering cycle or impurity removal cycle, mode, stage or phase. The phrase “washing fluid” also includes a washing fluid used to wash a biflow filter in which influent travels upwardly and downwardly in a filtering cycle or impurity removal cycle, mode, stage or phase.

The phrase “treatment unit” includes any structure that utilizes granular media to remove impurities from influent directed through the granular media. Accordingly, the phrase “treatment unit” includes but is not limited to a final polishing filter (e.g., downflow filter, upflow filter, biflow filter or pressure filter) or any device that pretreats influent prior to entering the final polishing filter (e.g., downflow clarifier, upflow clarifier, biflow clarifier or pressure clarifier).

The term “underdrain” includes any structure designed to direct a washing fluid through one or more layers of granular media to remove impurities in the one or more layers of granular media trapped during a filtering cycle or impurity removal cycle, mode, stage or phase. By way of example and without limitation, the term “underdrain” includes a structure formed from a plurality of underdrain lateral blocks, a Wheeler bottom underdrain and a header having a plurality of lateral pipes or conduits connected thereto (e.g., pressure filter) or other structure designed to direct a washing fluid through one or more layers of granular media. The term “underdrain” further includes lateral blocks having a porous plate or other structure allowing the underdrain lateral blocks to directly support one or more layers of granular media without any intermediate support element (e.g., one or more layers of gravel) as well as underdrain lateral blocks requiring one or more layers of gravel disposed between the underdrain lateral blocks and the one or more layers of granular media.

### FIGS. 1 and 2

FIGS. 1 and 2 depict a preferred form of underdrain anti-clogging structure, member, device or insert A in one of many possible different configurations without the associated fluid pressure sensor. A preferred underdrain anti-clogging structure, member, device or insert A includes screening portion 2 which preferably takes the form of an elongated body as depicted in FIGS. 1 and 2, a position orienting and/or attachment member 4 and an outer end structural support member 6.

While screening portion 2 is depicted as having a circular cross-section, screening portion 2 can have any suitable cross-sectional shape including but not limited to square, rectangular, elliptical and triangular.

Screening portion 2 is a washing fluid pass through and impurity trapping portion of the underdrain anti-clogging structure, member, device or insert A. Specifically, screening portion 2 has a plurality of openings sized to allow a washing fluid to pass through while trapping impurities in the washing fluid in the screening portion 2. In a most preferred form, screening portion 2 is a fine mesh screen formed from stainless steel with end piece or member 6 configured to maintain the terminal end portion of screening portion 2 in the desired shape wherein the size of the openings of the fine mesh screen is preferably less than 0.45 mm. However, the size of the openings of screening section or portion 2 can be readily varied depending on relevant factors including but not limited to the particular underdrain being used, the size of the media in the filter bed and/or the size of impurities expected to be present in the washing fluid.

Member 6 can be a solid member (i.e., without any openings or orifices through the washing fluid can exit of escape through). Alternatively, member 6 can be formed from a relatively rigid material having a screening portion or section similar to portion 2.

Screening portion 2 can include internal intermediate support members to maintain various intermediate sections of screening portion 2 in the desired shape. Any such intermediate support members preferably configured to allow a washing fluid to travel along and out screening portion 2 may be used including but not limited to one or more ring shaped intermediate support members having a large central opening allowing the free flow of washing fluid through the intermediate support members.

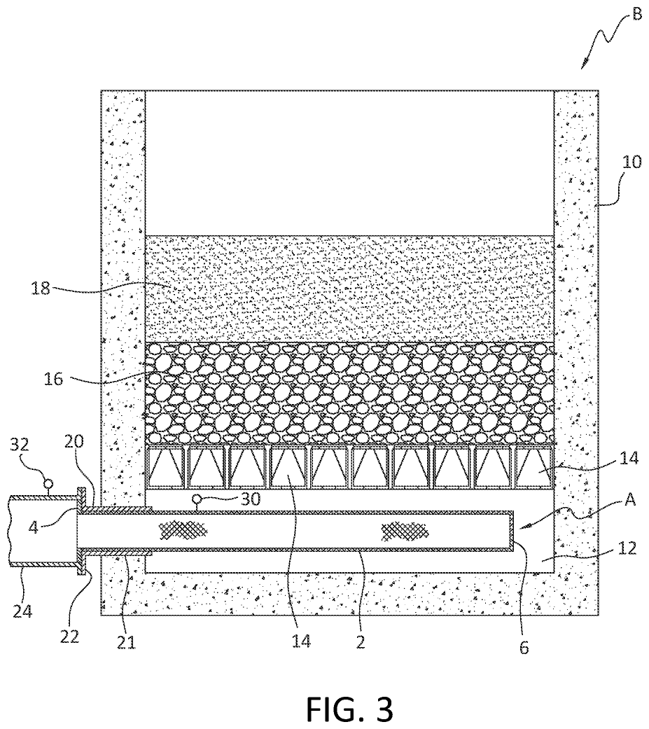

### FIG. 3

Referring to FIG. 3, one preferred treatment unit B is illustrated. Treatment unit B includes a compartment or housing 10. While housing 10 is shown as having an open upper portion thereof, housing 10 could be closed so that the treatment unit B is a pressure filter or pressure clarifier.

The housing 10 includes a flume 12 and a plurality of rows of underdrain blocks 14 positioned above and in fluid communication with the flume 12. Each row of underdrain blocks 14 can be formed by one or more underdrain blocks 14. A plurality of openings are formed in the bottom of the underdrain blocks 14 to allow fluid to flow between the flume 12 and underdrain blocks 14. The housing 10 includes a gravel support section 16 supporting a granular media filter bed 18 above the underdrain blocks 14. The gravel support section 16 may include one or more layers of gravel. It should be noted that the gravel support section 16 can be omitted where the underdrain blocks 14 are configured to support the granular media filter bed 18 directly on the underdrain blocks 14. For example, underdrain blocks 14 could have a porous plate or other structure that allows the underdrain blocks 14 to directly support the granular media filter bed 18.

Granular media filter bed 18 may be formed as a single layer of granular media or a plurality of layers of granular media. The granular media of the filter bed 18 can be sand layers or layers of any other suitable material for removing impurities from a fluid to be filtered or clarified.

Housing 10 includes a support and connecting member 20 extending through a suitably sized opening in the corresponding vertical wall of housing 10. Support and connecting member 20 can take the form of a flange having a central opening sized to allow underdrain anti-clogging member or device A to extend through the central opening of flange 20 so that screening section 2 is disposed in flume 12. While end 6 of the underdrain anti-clogging member or device A is shown as being spaced from an adjacent wall of housing 10, the underdrain anti-clogging member or device A can be configured so that end 6 abuts and/or directly contacts the adjacent wall of housing 10 or a support structure connected to the adjacent wall of housing 10 to support the terminal end of member or device A.

Flange 4 of the underdrain anti-clogging member or device A can be detachably be connected to lip 22 of flange 20 using any suitable fasteners (e.g., nuts and bolts) or the underdrain anti-clogging member or device A can be sized relative to flange 20 so that fasteners are not necessary (e.g., friction fit). Flange 4 can be provided with one or more through-holes 7 (see FIG. 2) extending through the flange 4 to detachably connect flange 4 to a corresponding component of the treatment unit. Flange 4 can be a plate that mates with lip 22 to support and maintain the underdrain anti-clogging member or device A in a desired operating position. Flange 4 can include a plate and a tubular portion extending inwardly from the plate wherein the tubular portion of flange 4 is sized to mate with the tubular portion 21 of flange 20 to provide further support for the underdrain anti-clogging member or device A and prevent device A from tilting or otherwise moving from a desired operating position. Tubular portion of flange 4 can extend into the screening section 2. The portion of screening portion 2 that extends the length of portion 21 of flange 20 when the underdrain anti-clogging member or device A is in an operating position can be free of openings or alternatively a seal can be provided between portion 21 and the corresponding portion of the underdrain anti-clogging member or device A to prevent washing fluid from leaking out of the treatment unit B.

Washing delivery vessel, conduit or pipe 24 can be permanently or detachably connected to lip 22 of flange 20 to provide a sealed connection between pipe 24 and flange 20. Where the pipe 24 is detachably connected to lip 22, this detachable connection can be achieved by any suitable fasteners including but not limited to nuts and bolts. One or more seals may be used to create the sealed connection between pipe 24 and treatment unit B.

If pipe 24 is permanently fixed to lip 22, pipe 24 can be cut to allow an individual to access any fasteners detachably connecting the underdrain anti-clogging member or A to lip 22 to readily remove the underdrain anti-clogging member or device A from the treatment unit B so that the underdrain anti-clogging member or device A can be cleaned or replaced. If the pipe 24 is detachably connected to lip 22 of flange 20, the underdrain anti-clogging member or device A can be removed by manipulating the corresponding fasteners making the detachable connection between pipe 24 and flange 20 to allow pipe 24 to be detached from flange 20 so that an individual can access and manipulate any fasteners detachably connecting flange 4 to lip 22 to allow for removal and/or replacement of the underdrain anti-clogging member or device A.

A pressure sensor 30 is operably connected to screening portion 2 of the underdrain anti-clogging member or device A. Preferably, pressure sensor 30 is connected to screening portion 2 or other portion of the underdrain anti-clogging member or device A so that the sensor 30 can be removed with the underdrain anti-clogging member or device A. The screening portion 2 can be sized relative to central opening passing through flange 20 so that pressure sensor 30 can be removed with the underdrain anti-clogging member or device A.

Pressure sensor 30 is positioned relative to the underdrain anti-clogging member or device A so that pressure sensor 30 senses the pressure of the flow of the washing fluid escaping or exiting the screening portion 2 during a washing cycle, stage, mode or phase. Pressure sensor 32 is operably connected to pipe 24 to sense, during a washing cycle, stage, mode or phase, the pressure of the flow of the washing fluid prior to entering the underdrain anti-clogging member or device A. By monitoring the pressure sensed by sensors 30 and 32 including pressure differential between sensors 30 and 32, an operator of the treatment unit B can readily determine if the underdrain anti-clogging member or device A is functioning properly. For example, if there is no or little difference in the fluid pressure sensed by sensors 30 and 32, then the underdrain anti-clogging member or device A has likely deteriorated to such an extent that it is no longer trapping any impurities in the washing fluid. If the pressure differential of the fluid pressure sensed by sensor 30 and the fluid pressure sensed by the pressure sensor 32 reaches or exceeds a predetermined value, then the operator of the treatment unit knows that the impurities trapped by the underdrain anti-clogging member or device A has reached a volume of trapped impurities precluding or unduly restricting the flow of washing fluid through the underdrain anti-clogging member or device A.

An alarm (audible or visual or both audible and visual) may be generated in either case, i.e., when there is little or no difference in pressure sensed by sensors 30 and 32 or when the pressure differential has reached or exceeded a predetermined value.

During a washing cycle, phase, stage or mode is being performed, a washing fluid is delivered to and through the underdrain anti-clogging member or device A by a washing fluid delivery system including a source of washing fluid (not shown) and pipe, conduit or vessel 24 connected directly or indirectly to the source of washing fluid. The source of washing fluid can be any suitable structure including but not limited one or more tanks or containers storing a washing fluid. The source of washing fluid can be elevated so that a pump is not needed to direct the washing fluid to the treatment unit. Alternatively, a pump can be provided for pumping the washing fluid from the source of washing fluid to the treatment unit.

Preferably, the underdrain anti-clogging member or device A is oriented in such a manner that any washing fluid supplied by pipe 24 to treatment unit B must pass through the underdrain anti-clogging member or device A. The screening portion 2 of the underdrain anti-clogging member or device A allows the washing fluid to escape or exit the underdrain anti-clogging member or device A and travel upwardly and into the underdrain blocks 14. The impurities in the washing fluid that have the potential to clog the underdrain blocks 14 are trapped in the underdrain anti-clogging member or device A. Openings in the upper portion of the underdrain blocks 14 allow the washing fluid to exit or escape from the underdrain blocks 14 and travel upwardly and uniformly through the filter bed 18 to remove impurities trapped in the filter bed 18 during a filtering or impurity removal cycle, phase, stage or mode.

While screening section 2 of the underdrain anti-clogging member or device A is preferably formed from a fine mesh stainless steel screen, screening section 2 can be formed from a flexible material that allows the screening section 2 to expand to increase the volume of impurities that can be trapped by section 2.

In another embodiment, pressure sensor 30 disposed in flume 12 can be operably connected to a controller (e.g., microprocessor) of the treatment unit B that controls the flow of a washing fluid to flume 12. The controller can discontinue the flow of a washing fluid when the pressure sensed by sensor 30 exceeds a predetermined value to prevent damaging the underdrain including but not limited to underdrain blocks 14 by a washing fluid having too high of a pressure to safely pass through the underdrain. The controller may control a pump (where a pump is used to pump washing fluid to flume 12) and/or shutoff value to discontinue the flow a washing fluid to flume 12. When the controller determines the pressure of washing fluid in flume 12 exceeds a safe pressure, the controller can immediately shutoff the pump if a pump is employed in the treatment unit B discontinuing the flow of a washing fluid to the flume 12. Where no pump is employed by treatment unit B, the controller can immediately close a shutoff valve located in the washing fluid delivery at a point before or just before the point washing fluid is supplied to flume 12. Even where a pump is used a shutoff valve can be used so that the controller closes the shutoff valve and ceases operation of the pump to discontinue the flow of washing fluid to flume 12. It should be noted that pressure sensor 30 in this embodiment may be used with or without the underdrain anti-clogging member or device A.

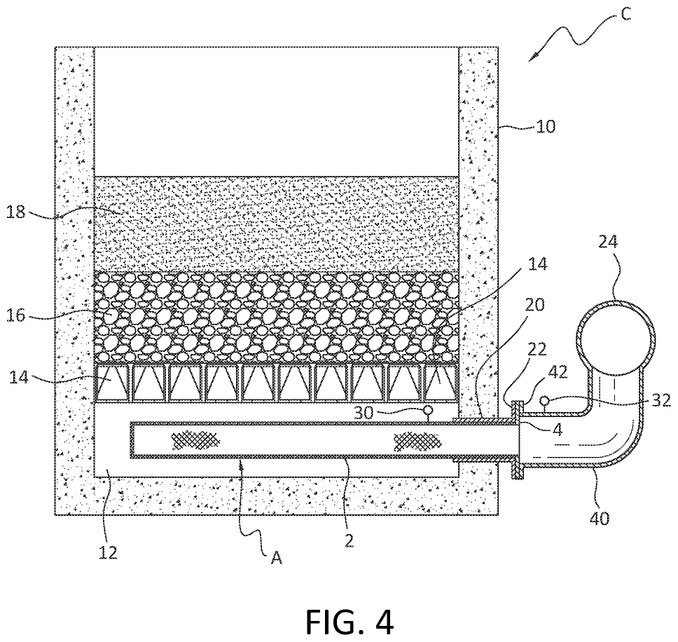

### FIG. 4

Referring to FIG. 4, a treatment unit C similar to treatment unit B is illustrated and, therefore, only the differences will be described. Components of treatment unit C that are the same as a corresponding component of treatment unit B are given the same reference numeral and/or reference letter.

Treatment unit C employs an elbow 40 to detachably connect pipe 24 to housing 10. Specifically, elbow 40 includes a lip or flange 42 detachably connected to lip 22 of flange 20. Any suitable fasteners including but not limited to nuts and bolts can detachably connect lip 42 to lip 22. Elbow 40 directs washing fluid from pipe 24 to the underdrain anti-clogging member or device A. One or more seals may be provided to ensure a fluid tight connection between pipe 24 and the underdrain anti-clogging member or device A.

The underdrain anti-clogging member or device A can be readily removed from treatment unit C for cleaning or replacement with a new underdrain anti-clogging member or device A by manipulating the detachable fasteners and then manipulating the end of elbow 40 adjacent lip 22 so that any detachable fasteners detachably connecting flange 4 to lip 22 can be accessed and manipulated so that the underdrain anti-clogging member or device A can be pulled out of flume 12. Pressure sensor 32 is preferably operably connected to elbow 40 to sense the washing fluid pressure just prior to entering the underdrain anti-clogging member or device A. Pressure sensors 30 and 32 are used to monitor the underdrain anti-clogging member or device A in the same manner described in connection with treatment unit B.

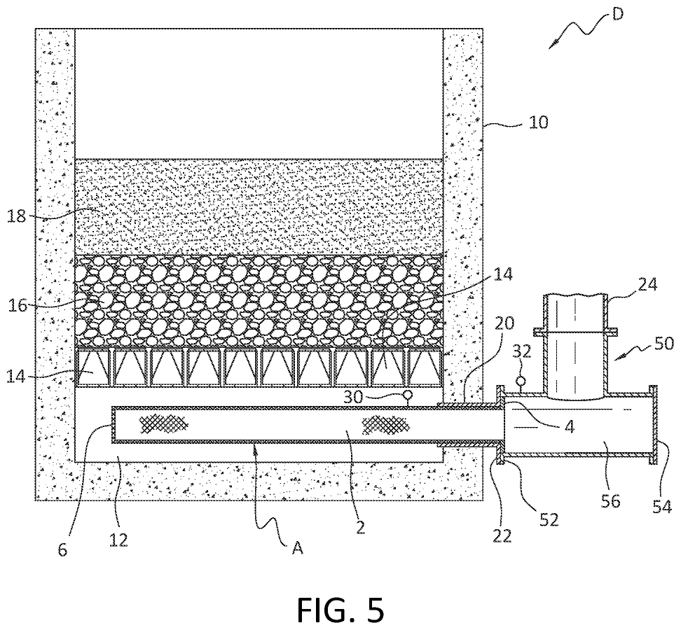

### FIG. 5

Referring to FIG. 5, a treatment unit D similar to treatment unit B is illustrated and, therefore, only the differences will be described. Components of treatment unit D that are the same as a corresponding component of treatment unit B are given the same reference numeral and/or reference letter.

Treatment unit D employs a T-connector 50 to detachably connect washing fluid supply pipe 24 to housing 10. Specifically, T-connector 50 includes a lip or flange 52 detachably connected to lip 22 of flange 20. Any suitable fasteners including but not limited to nuts and bolts can detachably connect lip 52 to lip 22. T-connector 50 preferably includes a removable end cap 54. Cap 54 can be threaded onto a corresponding portion of connector 50 or detachably connected to the corresponding portion of connector 50 using any suitable fasteners including but not limited to nuts and bolts. T-connector 50 directs washing fluid from pipe 24 to the underdrain anti-clogging member or device A. One or more seals may be provided to ensure a fluid tight connection between pipe 24 and the underdrain anti-clogging member or device A.

The underdrain anti-clogging member or device A can be readily removed from treatment unit D for cleaning or replacement with a new underdrain anti-clogging member or device A by removing end cap 54 and manipulating any detachable fasteners connecting flange 4 to lip 22 and subsequently pulling the underdrain anti-clogging member or device A out of flume 12 through hollow cavity 56 of connector 50. Pressure sensor 32 is preferably operably connected to connector 50 to sense the washing fluid pressure just prior to entering the underdrain anti-clogging member or device A. Pressure sensors 30 and 32 are used to monitor the underdrain anti-clogging member or device A in the same manner described in connection with treatment unit B.

While FIGS. 3 to 5 illustrate treatment units employing an underdrain having a plurality of rows of underdrain blocks, the present invention is not limited to treatment units having such underdrains. Rather, the present invention can be used in treatment units employing any other underdrain directing a washing fluid through a granular media including but not limited to Wheeler bottom type underdrains and underdrains in pressure filters or clarifiers having a header and a plurality of lateral pipes connected to the header to direct a washing fluid from the header into and uniformly through the granular media filter bed. In pressure filter or clarifiers, the screening portion of the underdrain anti-clogging member extends in and along a portion or the entirety of the inner hollow cavity of the header.

The preferred design of the underdrain anti-clogging member or device allows for retrofitting an existing treatment unit to include the underdrain anti-clogging member or device with only minimal modifications to the washing fluid delivery system or assembly of an existing treatment unit. Therefore, the present invention can be readily utilized in existing treatment units as well as in new treatment units.

While the preferred embodiments have been described as including two fluid pressure sensors, the present invention could be used with a single fluid pressure sensor sensing fluid pressure escaping or exiting the underdrain anti-clogging member or device and comparing this sensed pressure with an expected or known fluid pressure of the washing fluid prior or just prior to entering the underdrain anti-clogging member or device.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. An apparatus for preventing clogging of an underdrain of a treatment unit having a filter bed for treating water or wastewater, said apparatus comprising:
(a) an underdrain anti-clogging device operably associated with a washing fluid delivery member for directing washing fluid to the underdrain of the treatment unit to wash the filter bed of the treatment unit; and,
(b) said underdrain anti-clogging device being configured to allow the washing fluid to pass through said underdrain anti-clogging device and into the underdrain while trapping impurities in the washing fluid to prevent the impurities in the washing fluid from entering or clogging the underdrain.

2. The apparatus of claim 1, wherein:
(a) said underdrain anti-clogging device includes a fluid pass through and impurities trapping section having a plurality of openings wherein each of the plurality of openings are sized to allow a washing fluid to pass through each of the plurality of openings while trapping in said underdrain anti-clogging device impurities in the washing fluid that have the potential of clogging the underdrain.

3. The apparatus of claim 1, wherein:
(a) at least a portion of said underdrain anti-clogging device is disposed in a housing of the treatment unit housing the filter bed.

4. The apparatus of claim 1, wherein:
(a) said underdrain anti-clogging device is positioned relative to the washing fluid delivery member such that all washing fluid directed to the underdrain by the washing fluid delivery member must pass through said underdrain anti-clogging device prior to entering the underdrain.

5. The apparatus of claim 1, wherein:
(a) said underdrain anti-clogging device is removable so that said underdrain anti-clogging device can be cleaned or replaced with a new underdrain anti-clogging device.

6. The apparatus of claim 1, wherein:
(a) said underdrain anti-clogging device is configured to be removable without altering any corresponding component to such an extent that any corresponding component cannot be reused after removal of said underdrain anti-clogging device.

7. The apparatus of claim 1, further including:
(a) a first pressure sensor for sensing fluid pressure of a fluid exiting said underdrain anti-clogging device and a second pressure sensor for sensing fluid pressure of a fluid prior to entering said underdrain anti-clogging device.

8. The apparatus of claim 8, wherein:
(a) said first pressure sensor is attached to said underdrain anti-clogging device; and,
(b) said underdrain anti-clogging device includes at least a first flange detachably connected to one or more components of the treatment unit to support and facilitate removal of said underdrain anti-clogging device.

9. A method for preventing clogging of an underdrain of an existing or new treatment unit having an underdrain and a filter bed for treating water or wastewater, said method comprising the steps of:
(a) providing an underdrain anti-clogging device operably associated with a washing fluid delivery member for directing washing fluid to the underdrain of the treatment unit to wash the filter bed of the treatment unit; and,
(b) configuring said underdrain anti-clogging device to allow the washing fluid to pass through said underdrain anti-clogging device and into the underdrain while trapping impurities in the washing fluid to prevent the impurities in the washing fluid from entering or clogging the underdrain.

10. The method of claim 9, further including the steps of:
(a) providing a first pressure sensor for sensing fluid pressure exiting said underdrain anti-clogging device; and,
(b) providing a second pressure sensor for sensing washing fluid pressure prior to entering said underdrain anti-clogging device.

11. The method of claim 10, further including the step of:
(a) monitoring the pressure sensed by said first pressure sensor and said second pressure sensor to determine if said underdrain anti-clogging device is properly performing at least one function of said underdrain anti-clogging device.

12. The method of claim 10, further including the step of:
(a) monitoring the pressure sensed by said first pressure sensor and said second pressure sensor to determine if said underdrain anti-clogging device is filled or partially filled with trapped impurities to such an extent that a flow of washing fluid through said underdrain anti-clogging device is unduly restricted.

13. The method of claim 10, further including the step of:
(a) monitoring the pressure sensed by said first pressure sensor and said second pressure sensor to determine if said underdrain anti-clogging device has deteriorated to an extent that it cannot trap impurities in the washing fluid.

14. The method of claim 9, including the further step of:
(a) detachably connecting said underdrain anti-clogging device to the new or existing treatment unit so that said underdrain anti-clogging device can be removed to be cleaned or replaced with a new underdrain anti-clogging device.

15. A treatment unit for treating water or wastewater, said treatment unit including:
(a) a filter bed having one or more layers of filter media;
(b) an underdrain disposed below said filter bed;
(c) a compartment for housing said filter bed and said underdrain;
(d) a washing fluid delivery system for directing a washing fluid upwardly through the underdrain and said filter bed; and,
(e) an underdrain anti-clogging device operably associated with the washing fluid delivery system, said underdrain anti-clogging device being configured to allow the washing fluid to pass through said underdrain anti-clogging device and into the underdrain while trapping impurities in the washing fluid to prevent the impurities in the washing fluid from entering the underdrain.

16. The treatment unit of claim 15, wherein:
(a) the treatment unit is a water filter and the washing fluid is water; and,
(b) the water filter includes a flume below the underdrain and said underdrain anti-clogging device includes an elongated member extending in said flume.

17. The treatment unit of claim 16, wherein:
(a) said underdrain anti-clogging device includes a flange connected to said elongated member for supporting and detachably connecting said underdrain anti-clogging device to said water filter and a screening section that allows the washing fluid to pass through the screening section while trapping impurities in the washing fluid in said underdrain anti-clogging device.

18. The treatment unit of claim 15, further including:
(a) a first pressure sensor for sensing pressure of a fluid exiting said underdrain anti-clogging device, said first pressure sensor being disposed in a flume of said treatment unit below said underdrain.

19. The treatment unit of claim 16, further including:
(a) a second pressure sensor for sensing pressure of a fluid supplied by the washing fluid delivery system prior to entering said underdrain anti-clogging device.

20. The treatment unit of claim 18, wherein:
(a) said first pressure sensor is connected to said underdrain anti-clogging device such that said first pressure sensor is removed when said underdrain anti-clogging device is removed.

21. A method of monitoring, during a washing cycle, fluid pressure of a washing fluid prior to entering an underdrain of an existing or new treatment unit having an underdrain and a filter bed for treating water or wastewater, said method comprising the steps of:
(a) providing a pressure sensor in a flume or space below the underdrain to monitor a fluid pressure of a washing fluid during a washing cycle in which a washing fluid flows through the flume or space below the underdrain and into and through the underdrain;
(b) operably associating the pressure sensor with a controller that controls the flow of the washing fluid to the flume or space below the underdrain; and,
(c) discontinuing the flow of the washing fluid to the flume or space below the underdrain when the pressure sensed by the pressure sensor exceeds a predetermined value to prevent damaging the underdrain.
